(19) United States
(12) Patent Application Publication
(10) Pub. No.: US 2006/0182126 A1
(43) Pub. Date: Aug. 17, 2006

(54) Hybrid approach in design of networking strategies employing multi-hop and mobile infostation networks

(75) Inventors: Wing Ho Yuen, Astoria, NY (US); King Huang, East Brunswick, NJ (US); Norihiro Kondo, Plainsboro, NJ (US); Makoto Miwa, Tokyo (JP)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 11/058,560

(22) Filed: Feb. 15, 2005

(51) Int. Cl. H04L 12/56; H04L 12/28

(52) U.S. Cl. 370/400

(57) ABSTRACT

Mobile nodes communicate with each other to transfer packets between a source and a destination using a multi-hop network strategy for communicating packets in the forward direction and using a mobile infostation network strategy, alone or in combination with a multi-hop network strategy, for communicating packets in the reverse direction, thereby exploiting a controlled flooding communication scheme that balances the tradeoffs between capacity improvement and random packet delay. The system may be used in a variety of applications, including an intelligent highway information system.

### BACKGROUND OF THE INVENTION

The present invention relates generally to network strategies for routing information. More particularly, the invention relates to a routing strategy that utilizes a hybrid of both multi-hop and mobile infostation networks. While the invention has many uses, it will be described here in the context of an information routing system used in an intelligent highway reporting system.

Information routing systems can take many forms. Often, the optimal routing solution is dictated by the physical topology of the nodes among which the information must propagate. Mobile networked systems present a unique set of problems, in part due to the fact that the communicating nodes are not always disposed at fixed locations. As a consequence, communication between any two nodes may be sporadically broken when those two nodes become separated by a distance greater than the reliable transmission range. In some cases communication may be reestablished, whereas in other cases communication may be broken indefinitely.

In the literature, mobile ad hoc networks are classified into two basic paradigms: the multi-hop network and the mobile infostation network. In multi-hop networks, nodes communicate with one another using multi-hop routing. Multi-hop networks are sometimes also referred to as “ad-hoc networks.” In mobile infostation networks, nodes operate on a short transmit range and communicate only when they are in proximity. Node mobility thus plays an important role in how packets of information are transmitted. Each node may act as a relay node of other source and destination nodes, and will physically carry packets from a source node to a destination node as it moves.

Both of the existing paradigms have advantages and disadvantages. Multi-hop networks are generally not scalable. Thus, as the number of multi-hop nodes increases, the achievable throughput of a given source-destination connection goes asymptotically to zero. Mobile infostation networks, on the other hand, are more scalable. The achievable network throughput of a source-destination communication flow is independent of network size in the mobile infostation network. Nevertheless, capacity improvement comes at a cost of random packet delay. The delay is associated to the time scale of the mobility process. Thus, when nodes begin to move more slowly in physical space, the random packet delay increases.

The present invention treats the multi-hop and mobile infostation networks as two extreme instantiations of a general capacity-delay tradeoff. In addition, the present invention focuses on a networking strategy that also handles the tradeoff between instantaneous data delivery and robustness to network partitioning.

As an illustration of the hybrid approach taken by the present invention, an intelligent highway reporting system application is described. In such a system, urgent traffic reports of congestion, accidents or other roadside information at a given highway location are reported to warn the drivers of oncoming traffic ahead of time. In such an application, the number of packets generated, and the packet size are likely to be small, thus network capacity is not of pressing concern. Instead, because some messages may be of an urgent nature, there is a tight delay requirement for data delivery. If packet delay is large, a car behind the scene of a congestion hotspot may not be able to avoid the traffic and leave the highway exit in time. Similarly, a car may not have enough time to reduce to a safe speed before it passes through the scene of an accident.

Previous approaches in implementing an intelligent highway reporting system have been predisposed to the use of a cellular network. Cellular communication is a mature technology and its adoption in vehicular applications presents a comparatively small technical barrier. Nevertheless, routing packets through a cellular network is inherently expensive and inefficient.

### SUMMARY OF THE INVENTION

The present invention employs a hybrid approach in the architecture of a networking strategy. The hybrid approach exploits both multi-hop and mobile infostation network advantages while minimizing or addressing the respective disadvantages. In its presently preferred form, each node is committed to forward a packet if it is between the destination and the packet source location. Each packet contains a source coordinate in its packet field. A node can then simply decide whether to forward a packet or not by comparing its current coordinates with the appropriate packet field. Each packet also contains a timestamp of the time at which the original source packet was created. In case a packet is not able to reach the destination in a reasonable time, a transmitting node can detect this and will drop the packet. Each packet also contains an event field which contains a basic report of the event, such as a traffic congestion condition or an accident. Directional flooding is used on the network. When a node j receives a packet from node i, it will transmit the packet again, only if its location is closer to the destination than i's. This can be done simply by including a transmitter location field in the packet. The receiver node then determines if it forwards a packet, by comparing its current location with the transmitter location. Each packet also has a sequence number in the packet field. The sequence number prevents a node from sending the same packet over and over again in the flooding implementation. The node will inspect the sequence number in the packet and forward it once only to support controlled flooding.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a network communication diagram illustrating a multi-hop network;

FIG. 2 is a network communication diagram illustrating a mobile infostation network;

FIG. 3 illustrates a first strategy of connection establishment for two forward traveling nodes;

FIG. 4 illustrates a node encounter strategy for two forward moving nodes;

FIG. 5 illustrates a packet trajectory of the strategy of FIGS. 3 and 4;

FIG. 6 is a node communication diagram illustrating a node encounter strategy for two reverse traveling nodes;

FIG. 7 is a graph illustrating the packet trajectory of the strategy of FIG. 6;

FIG. 8 is a network communication diagram illustrating a connection establishment strategy for forward and reverse nodes;

FIG. 9 is a network communication diagram illustrating a node encounter strategy for forward and reverse nodes;

FIG. 10 is a graph illustrating the packet trajectory of the strategy illustrated in FIGS. 8 and 9;

FIG. 11 is a data structure diagrams illustrating a presently preferred data structure for the node and communication packet, respectively; and

FIG. 12 is a flow chart diagram illustrating the details of a presently preferred strategy based on controlled flooding.

### DETAILED DESCRIPTION OF THE PREFERRED EMBODIMENTS

The following description of the preferred embodiment(s) is merely exemplary in nature and is in no way intended to limit the invention, its application, or uses.

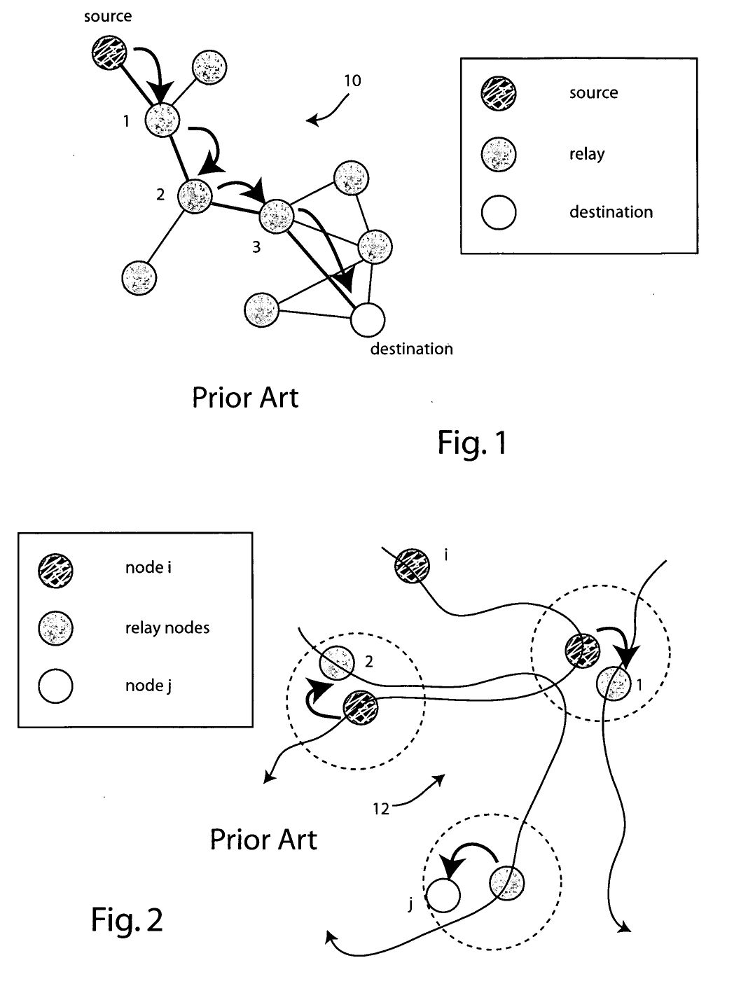

In order to understand the principles of the invention, a review of some basic packet routing techniques will first be provided. Referring to FIG. 1, a mobile ad hoc network is illustrated generally at 10. The nodes in this network communicate with one another without the need to use an infrastructure such as access points or base stations. Nodes may act as a source, destination and/or router of packets. There are two basic types of mobile ad hoc networks, the multi-hop network and the mobile infostation network. FIG. 1 dictates a multi-hop network.

In the multi-hop network of FIG. 1 it is usually assumed that nodes have a transmit range such that the network is connected (no network partitioning) most of the time. Since nodes are spatially distributed over a large area, any two nodes may not be able to communicate directly, due to the finite transmit range. When a source node has packets to transmit, typically it will invoke route discovery mechanisms to find a route to its intended destination. Routes are created on demand and route maintenance must be performed to update the routes as network topology changes. The routing mechanisms for this type of network are generally categorized as reactive routing schemes.

The second class of ad hoc networks, mainly the mobile infostation network, is illustrated at 12 in FIG. 2. In the mobile infostation network, nodes operate on even smaller transmit power. The network is heavily partitioned most of the time (i.e., nodes are out of range with respect to each other, thus there are breaks in the communication paths at any given time.)

In the mobile infostation network, any two nodes communicate only when they are in proximity and have a very good channel. Under this transmission constraint, any pair of nodes is intermittently connected as mobility shuffles the node locations. The network capacity of a mobile infostation network compares favorably to conventional multi-hop ad hoc networks. By way of comparison, the per node throughput in a multi-hop network drops to zero at a rate of O(1/(n ln n)^{1/2}) in the limit of large number of nodes n. Thus multi-hop networks do not scale with large network size. On the other hand, the per node throughput of a mobile infostation network is O(1), independent of the number of nodes. This capacity is achieved through a two-hop relay strategy.

In the mobile infostation network shown in FIG. 2, assume that each node in the network selects a random destination for unicast. In FIG. 2, we focus on a source node i, which has packets to deliver to a destination node. As time evolves, node i moves along a random trajectory and eventually runs into nodes 1 and 2. Although neither nodes 1 or 2 are the destination of node i, node i still relays the packets to them, with the expectation that when each of the relay nodes reaches the destination j, it will complete the second relay on behalf of node i. In steady state, each of the other n-2 nodes contains packets generated by node i and destined to node j. At any network snapshot, it is almost certain that the nearest neighbor of node j has packets addressed from node i and completes the second relay on behalf of node i. That is, the long run per node throughput is constant and is independent of network size. This capacity improvement comes from the exploitation of node mobility to physically carry the packets around the network, and is independent of the underlying mobility model. Nevertheless, the order of magnitude improvement in network capacity comes at a cost. End-to-end transmissions incur a random delay that is at the same time scale as the mobility process.

Multi-hop networks and mobile infostation networks are two extreme instantiations of the capacity-delay tradeoff over many possible networking paradigms. Mobile infostation networking allows for large capacity at the expense of a random unbounded delay. Multi-hop networking, on the other hand, permits expedited data delivery, but the network capacity is not scalable with the number of nodes. In order to expedite data dissemination in a mobile infostation network, multi-hop forwarding may also be used occasionally, if a node has not done so for other nodes for some time. Similarly, node mobility can also be exploited in multi-hop networks to improve network performance. For instance, node mobility is exploited to disseminate coordinates of all node locations without incurring any communication overhead. The location information is useful for nodes to make local routing decisions to the destination when geographic routing schemes are used.

In the context of an intelligent highway reporting system, capacity consideration is not a major concern. Due to the large inter-vehicular distance on highways, packet transmissions are sporadic. Packet size is likely to be small, since a packet contains only air control information such as source node coordinates, a time stamp of when the packet is created and the event type (accident or congestion). On the other hand, delay performance is more likely to be an important performance criteria. There is no reason to favor mobile infostation networking over multi-hop networking from a capacity-delay tradeoff perspective.

As will be further demonstrated with reference to the remaining figures, the hybrid approach adopted here identifies another set of tradeoffs between multi-hop networks and mobile infostation networks. Although multi-hop networking generally leads to expedited delivery of data packets, it is also vulnerable to network partitioning. In highway scenarios, inter-vehicle distance is typically large; node density is typically small. Network partitioning is likely due to low node density, aided by the fact that the highway network is essentially one-dimensional and is vulnerable to network partitioning. On the other hand, mobile infostation networking is robust to node mobility by design. Heavy network partitioning is the norm in mobile infostation networking and it does not demote efficient data delivery, which depends solely on node mobility. Packet delay of mobile infostation networking is also dramatically shortened, thanks to high node mobility and directional node mobility in highway applications. In particular, packet delay is also more deterministic with less variance. It is desirable to pursue a hybrid approach of mobile infostation networking and multi-hop networking to exploit multi-hop connections when network connectivity is available, and to resort to courier service of mobile infostation networks when a network partition occurs. This will ensure robust delay performance against a wide range of traffic and mobility scenarios.

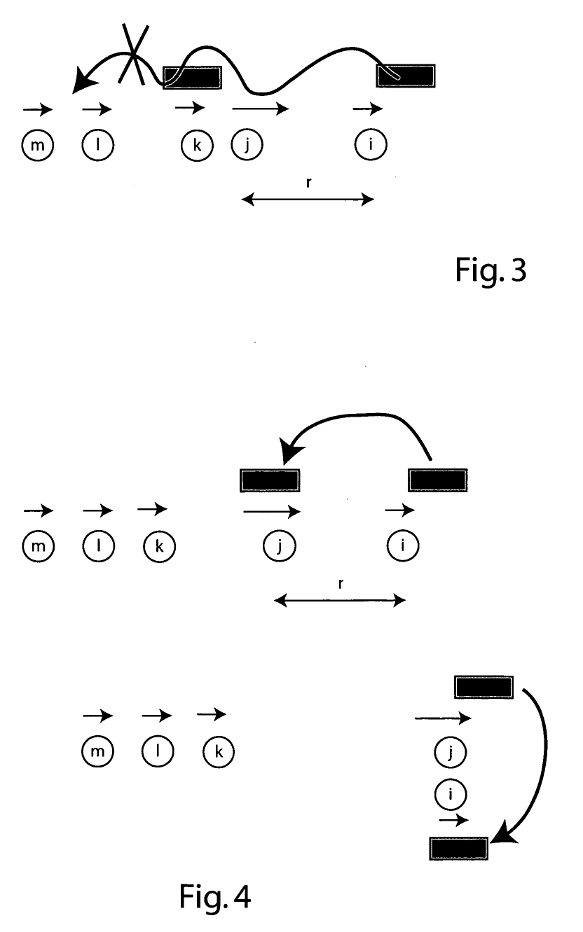

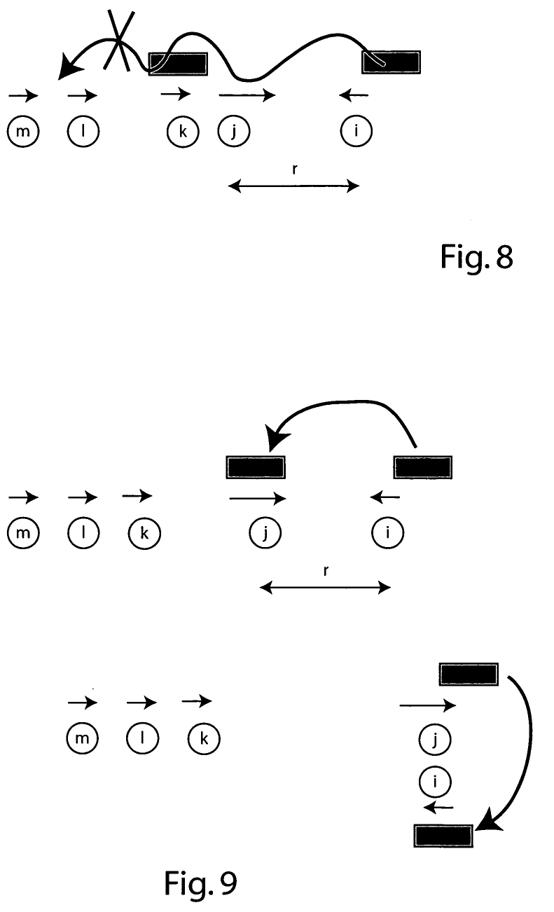

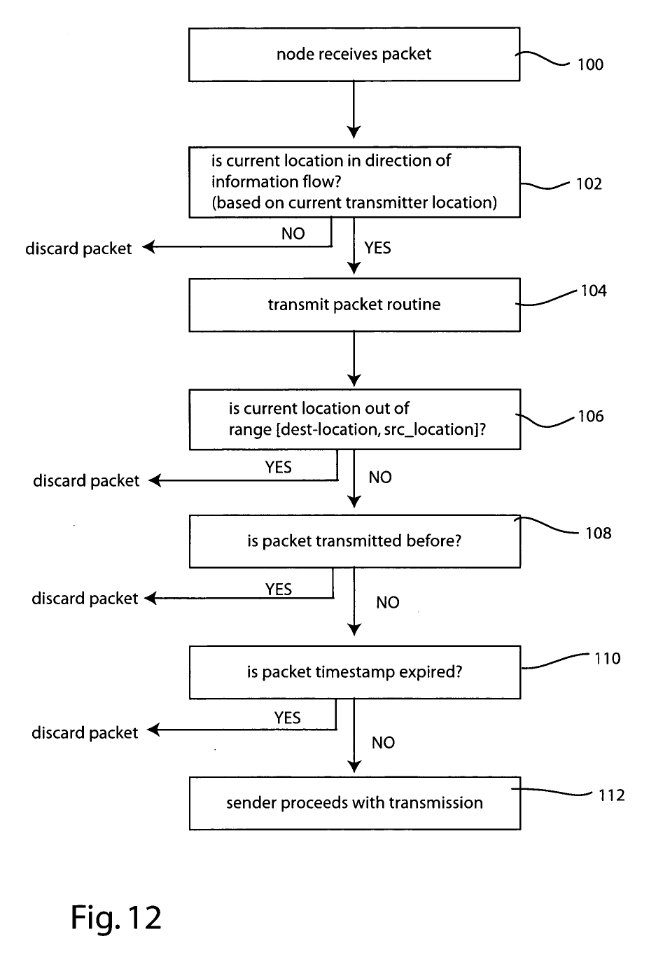

In FIGS. 3-11 we consider four strategies for constructing a mobile network. The strategies illustrated in FIGS. 3-5 and 6-7 are pure instantiations of multi-hop networking and mobile infostation networking, respectively. The latter strategies illustrated in FIGS. 8-10 and 11-12 are hybrid instantiations of mobile infostation and multi-hop networking. Presently preferred is the strategy of FIGS. 11-12 which our studies have shown offer the best delay performance compared with the others. An implementation for exploiting the strategies using existing 802.11 technologies is possible. Other technologies may also be used, however.

Referring to FIG. 3, Strategy I relies on multi-hop networking with forward traffic only. In other words, packets are passed from node to node (vehicle to vehicle) provided the vehicles are traveling in the direction of the destination location. As illustrated in FIG. 3, all nodes move in a forward direction. The packet is located at node i. Since nodes move at different random speeds, nodes may overtake or may be overtaken by each other. Suppose node j moves faster than node i. A connection establishment would occur when node j moves within the transmit radius of node i. When this occurs, node i transmits the packet to node j. When node j receives the packet, it will attempt multi-hop transmissions to transmit the packet toward the destination until the next network partition occurs, say at node k in our example.

Strategy II is illustrated in FIG. 4. With this strategy node j is not connected to node k. Thus the packet is transmitted from node i to node j in a single hop during connection establishment. Node j, however, will overtake node i eventually since it has a higher speed. When a node encounter occurs, the packet should be transmitted back to node i, which is closer to the intended destination. Note that in this strategy, the system alternates between two states. In the connection state, the node with the packet is connected to a node in the rear. The packet is transmitted using multi-hop forwarding toward the destination until another node partition occurs. The packet thus makes positive progress toward the destination instantaneously. In the no connection state, the packet makes negative progress since forward nodes are always moving away from the destination.

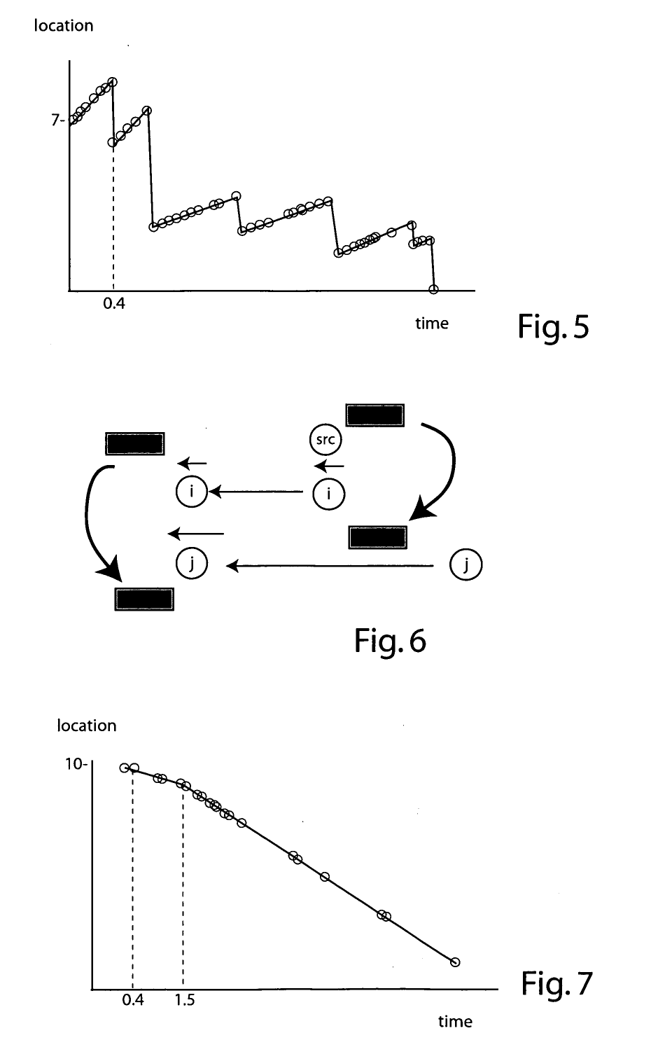

In Strategy I an alternation between connection and no connection states can be visualized by plotting the packet trajectory against time as shown in FIG. 5. A zigzag packet trajectory is observed, as the packet travels back and forth toward the destination. Initially, the packet is at a distance d=10 from the destination at origin. At time t=O the packet multi-hops to a node at d=7 instantaneously. The node carrying the packet then moves away from the destination in the no connection state until a new connection is made at time t=0.4. Again, a node spends negligible time in the connection state since multi-hop transmission is instantaneous in this model. Intuitively, the forward progress in the connection state depends on node density. At high node density, it is likely that a packet will traverse multiple-hops before it is stuck by a network partition. On the other hand, the distance traversed and the amount of time spend by a packed in the no connection state also depends on node density. If node density is high, network partitioning seldom occurs and the packet will not cling to the no connection state. Conversely, if node density is low, a packet spends significant time in the no connection state and the packet may not be reachable to the destination in finite time.

Under Strategy II, the packet is carried only by reverse traffic. Since the reverse node physically carries toward the destination, it is an instantiation of a mobile infostation networking scheme. Referring to FIG. 6, the packet initially originates at the source node. When a connection establishment is made between a reverse node i and the source node, the source relays the packet to the reverse node, which physically carries the packet toward the destination. Moreover, the reverse node i may be overtaken by a faster reverse node, such as node j, as time evolves. When a reverse-to-reverse node encounter occurs, node i can relay the packet to node j to expedite the packet transmission.

Referring to FIG. 7, the packet trajectory of Strategy II is plotted against time. Initially, the packet is at a distance d=10 from the destination at origin. Reverse node i arrives at the source at time t=0.4 and carries the packet toward the destination. Reverse node j is lagging behind but moving at a higher speed. Node j overtakes node i at time t=1.5 and the packet is relayed to node j to expedite packet delivery. It will be observed that packet trajectory is a piecewise linear function of time in this model. The vertices correspond to the event where a faster node overtakes the node carrying the packet.

The total packet delay is the sum of the waiting time for an encounter with a reverse node and the traveling time of the reverse node to the destination. For communication distances of practical interest d>>1/λ, where λ is the node arrival rate. Packet delay is dominated by the traveling time of the reverse node. Moreover, it is likely that a slower reverse node may be overtaken by a fast reverse node when d is large. Since reverse nodes travel exactly in the direction to the destination, and the packet courier is likely to be a fast node, packet delivery is much more efficient than in a planar network with random mobility.

From the foregoing it will be appreciated that Strategies I and II illustrate two extreme instantiations of networking approaches. Strategy I uses multi-hop transmissions exclusively. Although wireless transmissions have negligible delay in a typical offered load environment, the delay cost of having a network partition is high. Forward nodes always move away from the intended destination in the no connection state. This has important consequences in vehicular networks, where high node mobility dictates that the system will spend significant time in the no connection state. On the other hand, Strategy II avoids the network partitioning problem altogether by using the mobile infostation paradigm. In mobile infostation networks, delay performance depends on node mobility only and is unrelated to network partitioning. Communications occur when nodes physically carry the packet around the network. It is desirable to exploit instantaneous delivery inherent to multi-hop networking while also enjoying the robustness of mobile infostation networking against network partitioning. Strategy III, which will be illustrated next, is such a strategy where both multi-hop and mobile infostation networking paradigms are used in a hybrid form.

Referring now to FIG. 8, Strategy III is illustrated. Strategy III utilizes both forward and reverse traffic. For forward nodes, Strategy III uses the same connection establishment and node encounter procedures to other forward nodes as depicted FIGS. 3 and 4. Similarly, reverse nodes invoke the same procedures as shown in FIG. 6 for encounters with other reverse nodes. In addition to forward-to-forward node transactions and reverse-to-reverse node transactions, Strategy III also allows connection establishment and node encounters between forward and reverse nodes. With reference to FIG. 8, node i and node j are reverse node and forward node entities, respectively. When node i and node j are within the same transmit range, a connection establishment occurs. If node i carries the packet, it sends the packet to node j, with the expectation that node j will multi-hop the packet further, say to node k in this example. However, if node j is not connected to node k, then node j will catch up with node i eventually, as illustrated in FIG. 9. Since node j is moving away from the destination, the packet should be relayed back to node i to be delivered to the destination.

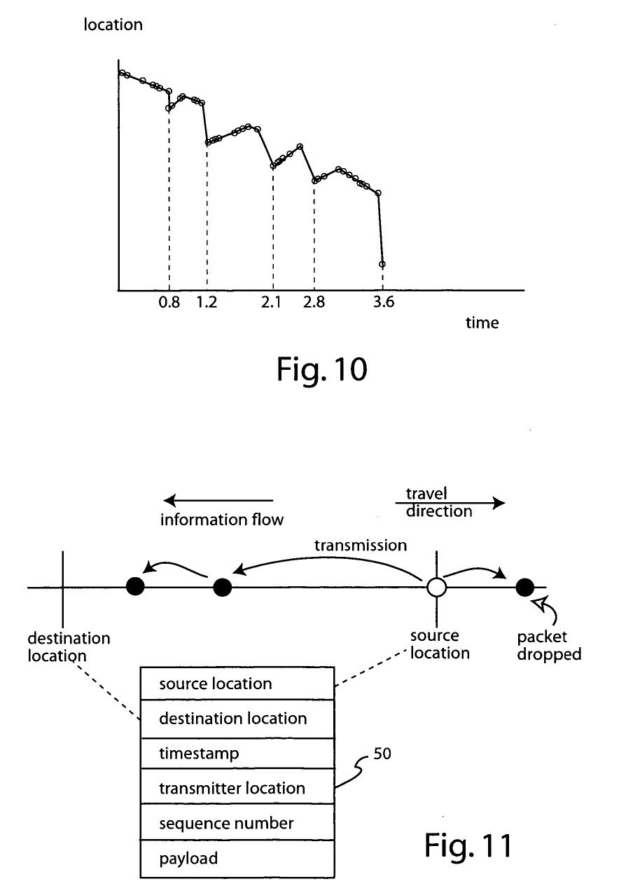

An example packet trajectory of Strategy III is shown in FIG. 10. Initially, the packet is carried by the reverse node. This strategy is opportunistic and takes advantage of instantaneous multi-hop transmission whenever the reverse node is connected to the forward nodes. In the example, multi-hop transmission is attempted at times T=0.8, 1.2, 2.1, 2.8 and 3.6. in the worst case scenario, the forward nodes spend significant time in the no connection state. The packet eventually gets back to the reverse node according to the rules illustrated in FIG. 9.

As shown in the example, the packets spend most of the time in the reverse node, as can be deduced by interpolating the trajectory of the reverse node. Eventually, at time T=3.6, the reverse node and the destination node are connected by forward nodes. The packet is then multi-hopped to the destination instantaneously.

Strategy III employs the user of multi-hop networking for forward traffic and mobile infostation networking for reverse traffic. However, it is possible to further reduce the packet's delay by utilizing reverse nodes for multi-hop transmission. The strategy designated as Strategy IV is similar to Strategy III and relies on multi-hop transmissions opportunistically. An example packet trajectory will be similar to that of Strategy III, with a potentially larger forward progress toward the destination in each opportunistic multi-hop transmission. The efficiency of multi-hop transmissions increases since multi-hop routes are set up from both forward and reverse nodes in this case. At low node density, multiple transmissions are sporadic and cannot be exploited. The packet will be carried by a reverse node most of the time. Thus the packet delay is similar to that of Strategy III, since mobile infostation networking is the predominant communication mode in both cases.

Strategy IV employs a form of flooding. In the presently preferred implementation of Strategy IV, nodes do not have an address. Each node is committed to forward a packet if it is between the destination and the packet source location. Each packet contains the source coordinates in its packet field. A node can then simply decide whether to forward a packet or not by comparing its current coordinates with the appropriate packet field. Each packet also contains a timestamp of the time when the original source packet was created. In the case where a packet is not able to reach the destination in a reasonable time, a transmitting node will drop the packet. Each packet also contains an event field which stores a basic report of the event, such as a traffic congestion or accident. Directional flooding is used on the network. When a node j receives a packet from node i, it will transmit the packet again, only if its location is closer to the destination than node i's. This can be simply done by including a transmitter location field in the packet. A receiver node then determines if it forwards a packet by comparing its current location with the transmitter location. Each packet also has a sequence number in the packet field. A sequence node prevents a node from sending the same packet over and over again in a flooding implementation. A node will inspect the sequence number in the packet and forward it only once to support controlled flooding.

Referring to FIG. 11, Strategy IV is illustrated. Specifically, FIG. 11 depicts the presently preferred data structure 50 and also illustrates the manner in which data packets are transmitted in both directions relative to the information flow direction. In a presently preferred embodiment the mobile nodes are provided with a memory configured according to data structure 50 so that they may store not only the payload (information about the event being communicated between source and destination, but also other metadata used by the system in operation.) The data structure thus includes a field or storage location to store the source location, such as by storing coordinates of the source node where the packet was originally generated. Similarly, data structure 50 includes a field or storage location in which to store the destination location, giving the coordinates of the intended destination of the packet. In addition, the preferred data structure includes a timestamp field or storage location into which is stored the time when the packet was originally sent, or alternatively, the time at which the packet is scheduled to expire. In either case, the timestamp is used to kill off packets that have not been delivered within a predetermined time. The data structure 50 also includes a storage location or field where the transmitter location is stored. This field contains the current location of the transmitting node when the packet is transmitted. A sequence number field or storage location stores a sequence number used to uniquely identify packets. Duplicate packets are thus readily detected because they bear the same sequence number.

In the illustrated Strategy IV, information flows from source to destination as indicated. Direction of travel for a given node can be generally in a direction opposite to that of the information flow or in a direction the same as the information flow. In this regard, the relationship between the direction of information flow and the direction of travel is a relative one. The direction of information flow and direction of travel do not need to be parallel, but rather they can be in an angular relationship. The direction of travel and direction of information flow would be deemed in the same direction so long as the direction of travel and direction of information flow both contain vector components that are parallel and headed in the same direction. The same would be true of information flow and travel direction that are deemed in opposite directions. In such case, the vector components would be parallel but headed in opposite directions.

Referring to FIG. 12, the presently preferred embodiment of Strategy IV will now be described. At step 100 a first node of the plurality of mobile nodes receives a given packet. At step 102 the receiving node determines if it currently traveling in the direction of information flow. If not, the packet is discarded. If so, step 104 transmits the packet, using an appropriate packet transmit routine, to a neighboring packet within range. Then, at step 106, the packet is tested to determine whether the current location is outside a predetermined range defined by the source and destination locations. If so, the packet is discarded. Otherwise, the packet is next tested to determine if it has been transmitted before. This is done at step 108 by examining the sequence number and comparing with sequence numbers previously transmitted. If the packet has been transmitted before, it is discarded. Otherwise, step 110 examines the packet to determine if its timestamp is expired. As previously explained, the timestamp can either be implemented by stamping the packet at the time of transmission, or it can be stamped with an expiration time calculated as a predetermined interval after the transmission time from the source location. If the timestamp has expired, the packet is discarded. Otherwise, the packet is sent to the neighboring node.

Since flooding is used in the network layer, MAC layer broadcast should be used in a way to preclude the use of request-to-send (RTS) packets and clear-to-send (CTS) packets in an 802.11 implementation. This considerably increases the collision probability of packets, due to the hidden terminal problem. A proper choice of transmit range, however, will significantly alleviate the hidden terminal problem.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of routing network packets from a source node to a destination node using a plurality of mobile intermediate nodes having an associated travel direction, comprising the steps of:
receiving a packet at a first intermediate node and determining a direction of information flow in relation to said first intermediate node;
if the travel direction of said first intermediate node corresponds to the direction of information flow, then transmitting the packet to a second mobile intermediate node; and
using said second intermediate node to proceed with transmission of said packet towards said destination node.

2. The method of claim 1 further comprising if the travel direction of said first intermediate node does not correspond to the direction of information flow then discarding said packet.

3. The method of claim 1 further comprising determining if the current position of said packet is outside a predetermined range relative to the locations of said source node and said destination node and discarding said packet if the current position is outside said predetermined range.

4. The method of claim 1 further comprising testing at one of said first and second intermediate nodes whether said packet has been transmitted by that node before and, if so, discarding said packet.

5. The method of claim 1 further comprising attaching a timestamp to said packet at said source node and testing at one of said first and second intermediate nodes if a predetermined time has expired since the attachment of said timestamp and, if so, discarding said packet.

6. A routing system for routing network packets between a source and a destination, comprising:
a plurality of mobile nodes each having an associated travel direction and adapted to send and receive packets over a finite transmission range;
said nodes each having a memory configured to store data elements a through d:
(a) source location
(b) destination location;
(c) current location; and
(d) payload information
each of said nodes each being configured to determine if the current location is in direction of information flow as determined by comparing source location and destination location and to transmit said packet to another of said nodes if the current location of said another of said nodes is in the direction of information flow.

7. The routing system of claim 6 wherein said nodes are further configured to ascertain a range based on said source and destination locations and to delete said packet if the current location is outside that range.

8. The routing system of claim 6 wherein said memory is further configured to store a node sequence number and wherein said nodes are further configured to discard said packet if a packet with the same sequence number has been transmitted by that node before.

9. The routing system of claim 6 wherein said memory is further configured to store a timestamp corresponding to the time the packet was transmitted from the source location and wherein said nodes are further configured to discard said packet if a predetermined time has lapsed since the timestamp was generated.

10. The routing system of claim 6 wherein said mobile nodes transmit packets among themselves using wireless network transceivers.

11. A hybrid mobile ad hoc network architecture comprising:
a plurality of mobile nodes each adapted to communicate with each other to transfer packets from a source to a destination;
said mobile nodes each being configured to concurrently implement the following network strategies:
a multi-hop network strategy and
a mobile infostation network strategy.
said mobile nodes being further configured such that said multi-hop network strategy is used to communicate packets between mobile nodes traveling in a first direction and such that said mobile infostation network strategy is used to communicate packets between mobile nodes traveling in a second direction opposite to the first direction.

12. The network architecture of claim 12 wherein said multi-hop network strategy is also used to communicate packets between mobile nodes traveling in said second direction.
